(19) United States
(12) Patent Application Publication
(10) Pub. No.: US 2015/0245234 A1
(43) Pub. Date: Aug. 27, 2015

(54) Dynamic Point-To-Point Spectrum Licensing

(71) Applicant: INTERDIGITAL PATENT HOLDINGS, INC., Wilmington, DE (US)

(72) Inventors: Arnab Roy, East Norriton, PA (US); Philip J. Pietraski, Jericho, NY (US); Ravikumar V. Pragada, Collegeville, PA (US)

(73) Assignee: InterDigital Patent Holdings, Inc., Wilmington, DE (US)

(21) Appl. No.: 14/424,503

(22) PCT Filed: Aug. 28, 2013
(86) PCT No.: PCT/US13/56951

§ 371 Date: Feb. 27, 2015

Related U.S. Application Data
(60) Provisional application No. 61/694,042, filed on Aug. 28, 2012.
(60) Provisional application No. 61/775,138, filed on Mar. 8, 2013.

(51) Int. Cl. H04W 24/10; H04W 72/04; H04W 52/24; H04W 16/14; H04W 16/28

(52) U.S. Cl. CPC H04W 24/10; H04W 16/14; H04W 16/28; H04W 52/243; H04W 72/0453

(57) ABSTRACT

Systems, methods, and instrumentalities are provided to implement granting a license to a millimeter wave base station (mB) in a wireless network. The mB may send a license request. The license request may be associated with a beam direction in a frequency band. The mB may receive a measurement schedule. The mB may take an interference measurement, e.g., in accordance with the measurement schedule. The interference measurement may be associated with one or more of the beam direction, a frequency band, or an assigned time period. The mB may send the interference measurement to the license coordinator. The mB may receive a temporary license for the beam direction in the frequency band. The temporary license may include a first transmit power restriction. The mB may receive an instruction to send a signal burst. The mB may receive a non-temporary license. The non-temporary license may include a second transmit power restriction.

### CROSS REFERENCE TO RELATED APPLICATIONS

This application claims the benefit of U.S. Provisional Patent Application Nos. 61/694,042 filed on Aug. 28, 2012, and 61/775,138 filed on Mar. 8, 2013, the contents of which are hereby incorporated by reference herein.

### BACKGROUND

For the last few decades there has been an increasing demand for data and data delivery capacity of wireless networks. The total spectral capacity has continued to increase. In order to meet the rapidly growing demand for mobile data, smaller cells may be used. As a function of the improved coverage and capacity, subscribers may experience better voice quality data rates and battery life of mobile devices using smaller cells (e.g., over connecting to macro cells alone).

Small cells (e.g., femtocells, microcells, wireless local area networks (“WLAN”). etc.) may imply an increased spatial reuse of the same spectrum and a way to achieve greater capacity. The cost of network deployments may increase as the number of infrastructure nodes grows. In order to limit network deployment costs, wireless backhaul may be used. Licensed millimeter wave spectrum may be used for cost effective high data-rate fixed links. Licensing mechanisms of such millimeter wave spectrum for high speed backhaul links may not take into account various factors including, for example, interference due to reflection front physical objects.

### SUMMARY

Systems, methods, and instrumentalities are provided to implement granting a license to a millimeter wave base station (mB) in a wireless network (e.g., a 3GPP based wireless network). The mB may send a license request (e.g., to an eNB or a license coordinator). The license request may be associated with a beam direction in a frequency band. The mB may receive a measurement schedule. The measurement schedule may include one more of a start time or a transmission duration of a signal burst.

The mB my take an interference measurement, e.g., in accordance with the received measurement schedule. The interference measurement may be associated with one or more of the beam direction, a frequency band, or an assigned time period. The interference measurement may comprise an interference measurement associated with a transmission from an existing mB (e.g., the existing mB may have an existing license, may be in the area of the mB, may be scheduled to transmit in accordance with the measurement schedule, and/or may be scheduled to transmit in accordance with the interference measurement parameters). The mB may send the interference measurement to the license coordinator For example, the mB may send the interference measurement to the license coordinator via an evolved NodeB (eNB). The mB may receive a temporary license for the beam direction in the frequency band (e.g., if the interference measurement indicates that interference is below a threshold). For example, the temporary license may be provided for one or more directions.

The mB may transmit under the temporary license. For example, the mB may receive an instruction to send a signal burst (e.g., according to a transmission schedule) and a first transmit power restriction (e.g., for tile signal burst). One or more of these may be part of the temporary license or may be signaled separately. The mB may send the signal burst, e.g., in one or more directions using the first transmit power restriction. The mB may send a request for a non-temporary license (e.g., after transmitting the signal burst). The mB may receive a non-temporary license. For example, the license coordinator may send the non-temporary license if the signal burst did not cause a level of interference with an existing mB, for example, the existing mB measured interference from the signal burst as being below a threshold). The non-temporary license may include a second transmit power restriction. The mB may send transmissions using the non-temporary license and the second transmit power restriction. The non-temporary license and/or second transmit power restriction may be less restrictive than the temporary license.

An mB may surrender a license (e.g., a link license), e.g., by sending a link surrender message. The link surrender message may include a link identifier. The mB may receive an acknowledgement for the link surrender message.

### BRIEF DESCRIPTION OF THE DRAWINGS

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of an example radio access network and an example core network that may be used within the communications system illustrated in FIG. 1A.

FIG. 1E is a system diagram of an example radio access network and an example core network that may be used within the communications system illustrated in FIG. 1A.

FIG. 2 illustrates an exemplary point-to-point spectrum licensing architecture.

FIG. 3 illustrates exemplary system architecture with two eNBs belonging to different networks.

FIG. 4 illustrates an exemplary message sequence chart for automated licensing.

FIG. 5 illustrates an exemplary frame structure for an autonomous link setup.

FIG. 6 illustrates an exemplary frame structure for, e.g., optimized autonomous link setup.

FIG. 7 illustrates an example of setting up an autonomous full link setup (e.g., optimized autonomous full link setup).

### DETAILED DESCRIPTION

A detailed description of illustrative embodiments will now be described with reference to the various figures. Although this description provides a detailed example of possible implementations, it should be noted that the details are intended to be exemplary and in no way limit the scope of the application. In addition, the figures may illustrate message sequence charts, which are meant to be exemplary. Other embodiments may be used. The order of the messages may be varied where appropriate. Messages may be omitted if not needed, and, additional messages may be added.

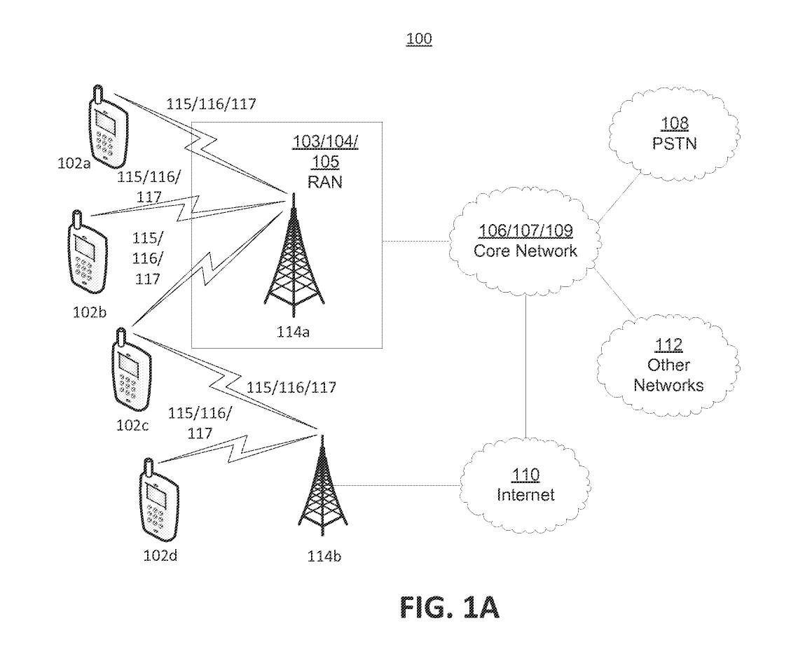

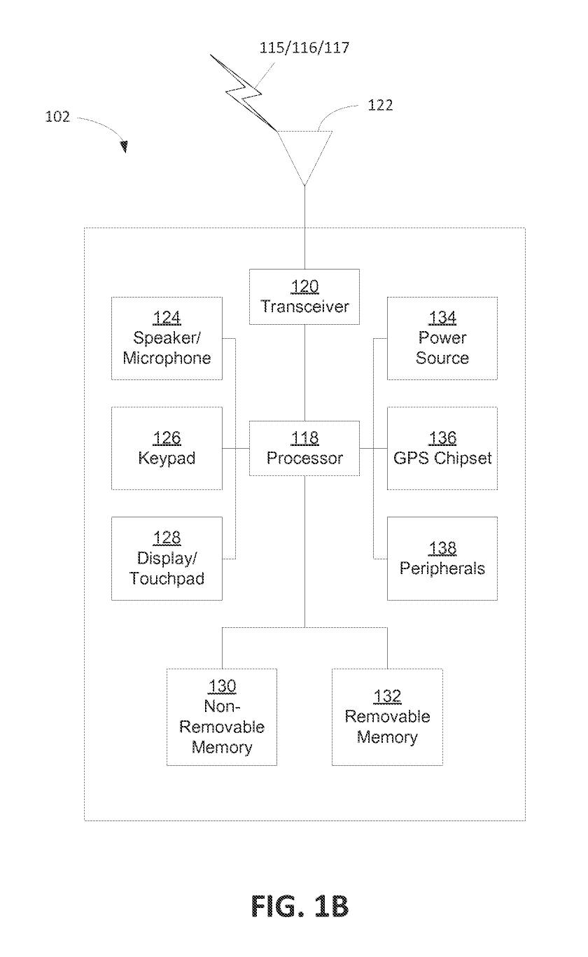

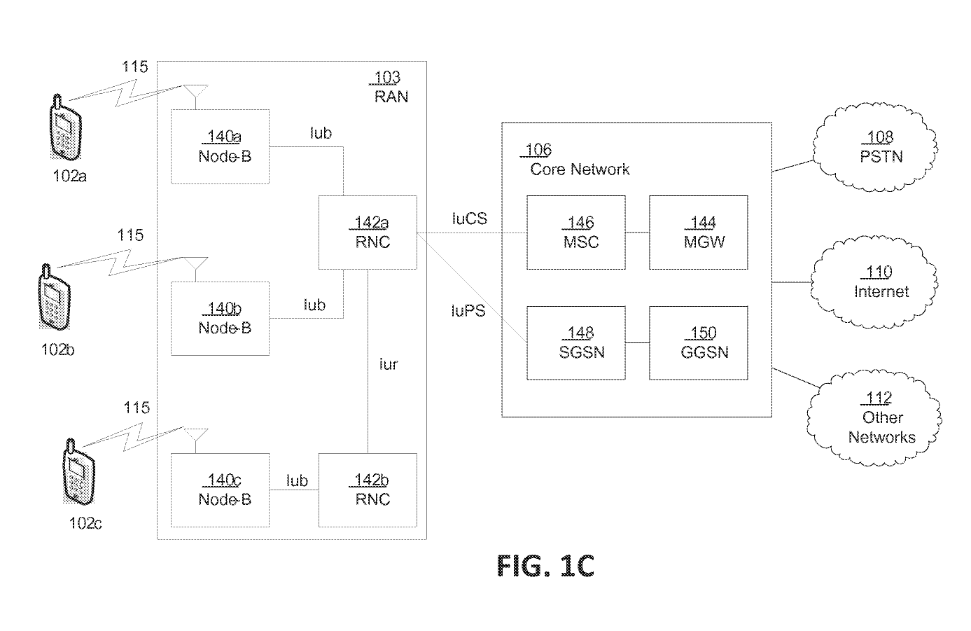

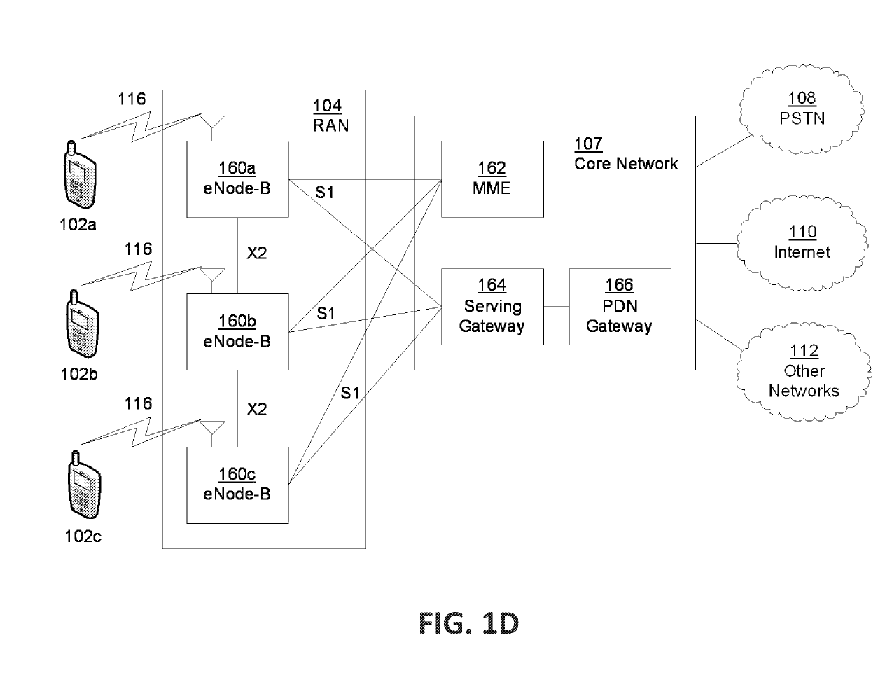

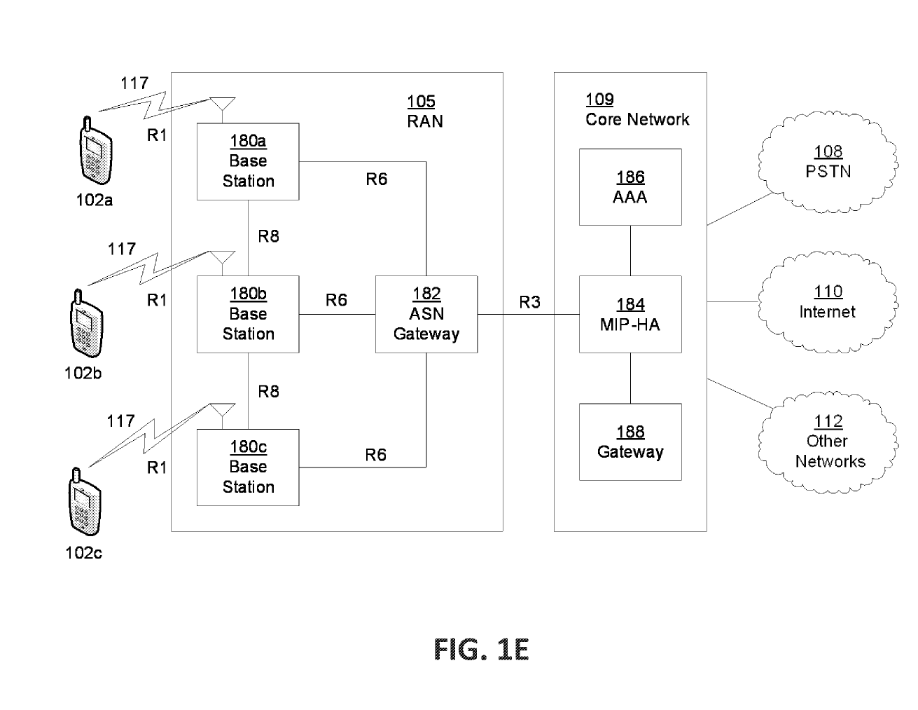

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include wireless transmit/receive unit (WTRU), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site con(roller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as abase station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RE), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

in an embodiment, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (1S-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet an embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over interact protocol (VoI) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with a RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCPIP internet protocol suite. The networks 112 may include wired or wireless communications networks owned and/or operated by other service providers. For example, the networks 112 may include a core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any, type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In an embodiment, the processor 118 may access information from, and store data in, memory that is not physically located on the WTRU 102, such as on a server or a home computer (not shown

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102. may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142h may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro diversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and or operated by an entity other than the core network operator.

The RNC 142a in the RAN 103 may be connected to the, MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116, The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102h, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the erode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 1601), 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an Si interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102h, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices, For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment, The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E. the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) h the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking then networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Many countries have allocated one or more frequency bands for ultra-high capacity point-to-point communications. For example 71-76 GHz and/or 81-86 GHz, (International Telecommunications Union (ITU) e-band) frequencies may be permitted worldwide, e.g., for point-to-point communications. The decision of allocating a band may be made based on characteristics, e.g., high frequency propagation physics, high data rate radio systems, etc. The transmission properties of very high frequency millimeter-waves may enable simpler frequency coordination, interference mitigation, and path planning than lower frequency bands. Licensing fees based on the amount of data transmission or bandwidth usage may result in tariffs that may be high for high data rate systems. Gigabit per second wireless systems may be penalized and adoption and competition may be discouraged.

Several national spectrum regulators may manage e-band using, e.g., light licensing techniques. Light licensing may reflect the ease of coordinating, registering and licensing, and setting license fees that may cover administrative costs, but do not penalize the high data rates and bandwidths that may be utilized by ultra-broadband services. The light licenses may award a link operator first come first served link registration rights, and full interference protection benefits, e.g., of a license, which may be referred to as a link liucense. Because administration is vastly reduced, the cost of analyzing and issuing light licenses may be less. If this cost is reflected in the fee levied for the license, adoption of and competition for high data rate services at the e-band frequencies may be encouraged.

A light licensing model may include multiple processes. A nationwide license may be obtained by the network operator from the regulator, followed by individual point-to-point link deployment that may use a database lookup to avoid interference, e.g., with existing users of the band. A per-link cost may reserve the link, e.g., for a period of time, ten years for example. The accompanying emission and antenna requirements may limit the use of these bands for long-range fixed point-to-point links, which may require expensive, usually fixed antenna set-up.

In a light licensing model, the credentials of a network operator may be verified, e.g., by the spectrum regulator. The operator may be assigned a public identifier (e.g., a call-sign) and a private key. The network operator may provide the public identifier and the private key to each of its nodes, e.g., in a secure manner. A node at startup may execute an authentication key generating algorithm that may take the network identifier, private key, and the node's identification code as its input to generate a derived authentication key. The derived key may be transmitted to the regulator's authentication server, e.g., over the internet along with the network and/or node identifiers. The authentication server may use, for example, the received network and/or node identifiers, and the stored network private key to generate its own authentication key. The authentication server may use the same algorithm as the client node. A match may indicate that the client node is authentic, The authentication result may be signaled to the node, e.g., via an authentication complete message over the internet.

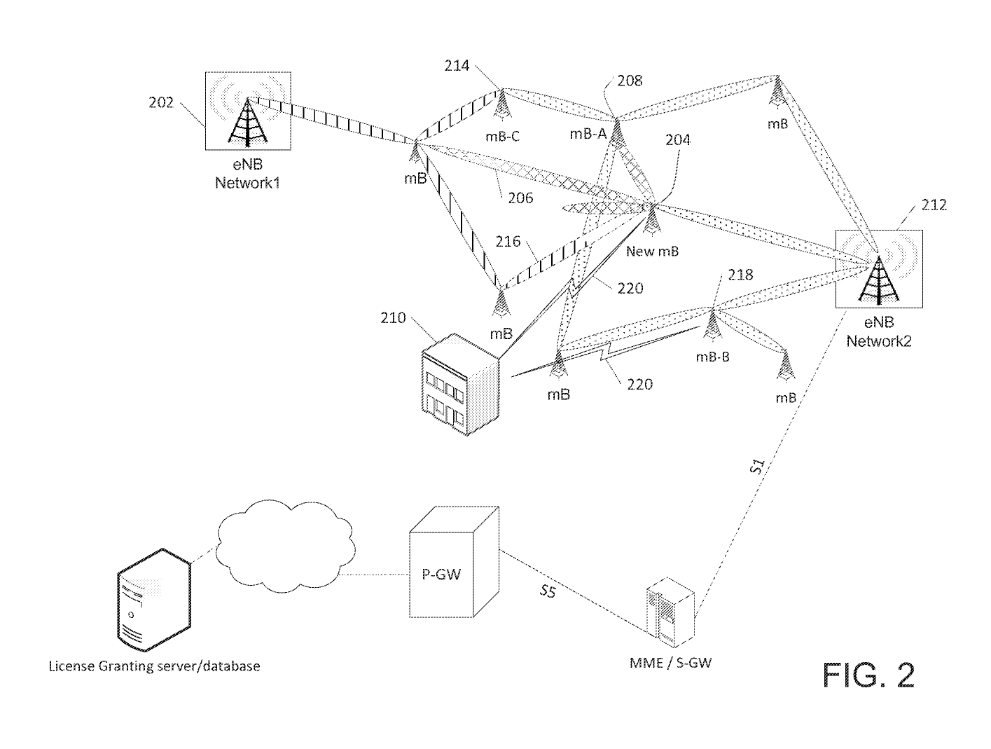

Light licensing rules for E-band spectrum may rely on database lookup for interference assessment. The static method may not take into account terrain features, obstructions, and/or physical structure reflective interference, etc., when deciding link viability. FIG. 2 illustrates an exemplary point-to-point spectrum licensing architecture. As illustrated by example in FIG. 2., building reflections may not be taken into account when granting licenses. As illustrated by example in FIG. 2, network 1 202 may request two licenses for the new mB 204. A license for the link 206 may not be granted, e.g., due to mB-A 208 in network 2, 212. A license for the link 216 may not be granted, e.g., due to reflection 220 off building 210 interfering with mB-B 218 in network 2, 212. mBs may connect to multiple meshes. mB-C 214 may join network 1 202 and network 1 may advertise mB-C. 214 to other networks and may permit network 2 to buy a license for a link to its network. The provider of network 1 202 may buy the link and sell the service to the provider of network 2 212.

A point-to-point link may experience interference that may not be captured by a database took-up system. Stringent emission requirements may lead to increased antenna costs, thereby restricting their use to tong-range point-to-point links. A more flexible system that may allow variable antenna beamwidth and may adjust link charges accordingly may lead to better utilization of the spectrum, e.g., by a wider class of transceivers.

The database lookup system may provide for a fixed long-term link license. Although there are some requirements, there may be no motivation for the license holder to optimize link utilization. A pricing mechanism that may allow variable link rates based on transceiver location, antenna configuration, time of day, and/or other factors may reflect spectrum costs and encourage more efficient utilization.

Methods, systems, and instrumentalities are provided herein for granting licenses for point-to-point communication links (e.g., highly directional links). Licenses may be allowed for multiple directional links, e.g., sharing the same space and frequency band. Methods, systems, and instrumentalities are provided for allotting, holding, and releasing licenses based on on-site measurements by constituent nodes forming the links. The methods, systems, and instrumentalities provided may be applicable to millimeter wave and/or higher frequencies where highly directional link formation may be used.

Methods, systems, and instrumentalities are provided for millimeter wave base-stations (mBs) to establish point-to-point links, e.g., for backhaul links, using licensed spectrum. In a particular area, instead of a single license for the whole spectrum, individual licenses may be granted to the mBs, e.g., for multiple directional point-to-point links. The point-to-point links may be associated with a unique license that may provide immunity from future interference due to newly established links. The mBs may be controlled by an evolved NodeB (eNB). The eNB may communicate over the interact, e.g., with a central license granting entity (e.g., a license coordinator) on behalf of the mBs to manage individual link licenses. The mBs may have an independent link to the internet and therefore, to the license coordinator. Individual link license costs may depend on factors, such as location, time of day, and/or other factors.

In the light-licensing model for c-band frequencies, the licenses may be dynamic, such that nodes may apply for various license durations on demand. The light licensing model may release link licenses when they are no longer needed. Licenses may be granted after making network-wide measurements, e.g., to ensure that existing licensed links are unaffected by the introduction of a directional link. Link licenses may be shared and/or traded between operators, with established rules for accountability. The light-licensing system may include different levels of licensing to facilitate operational flexibility.

Interference assessment and license grant functions may be managed by a license coordinator. The license coordinator may allocate interference assessment periods, receive mB interference reports from the eNBs, and may issue temporary and/or final licenses, e.g., based on the measurement reports. Nodes belonging to a particular network operator may communicate with a controller for network-related coordination.

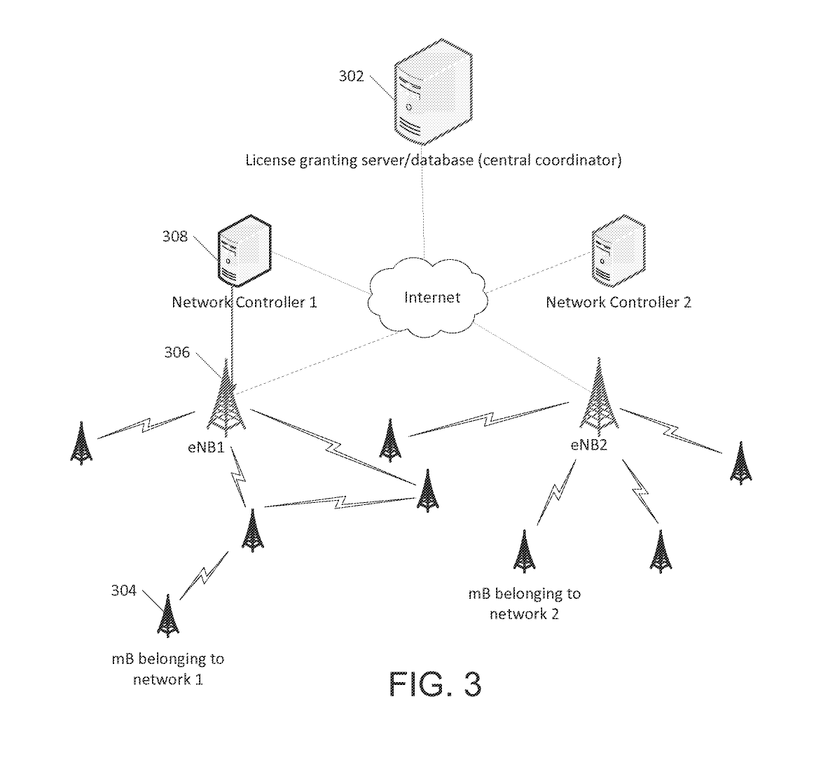

FIG. 3 illustrates exemplary system architecture with two eNBs belonging to different networks and their associated mBs. The eNBs may communicate with the license granting server/database 302 (e.g., a central coordinator), e.g., through Serving Gateways (S-GWs), Packet Gateways (P-GWs) (not shown in FIG. 3), etc. A license coordinator may be referred to as a central coordinator, mBs may have the ability to generate electronically steerable beams to point towards their neighbors. A single electronically steerable beam may be active at a given time per mB. An mB 304 may generate multiple simultaneous beams. An eNB 306 may be responsible for authenticating the mBs in its network. The eNB may communicate with the coordinator 302, e.g., on behalf of the mBs. The eNB may hold individual link licenses for its associated mBs. The eNB 306 may communicate on behalf of the mB with the network controller 308 and/or the central coordinator 302 to manage licenses and schedules. The mBs across separate networks may be synchronized, e.g., via an accurate common clock source such as Global Positioning System (GPS) reference.

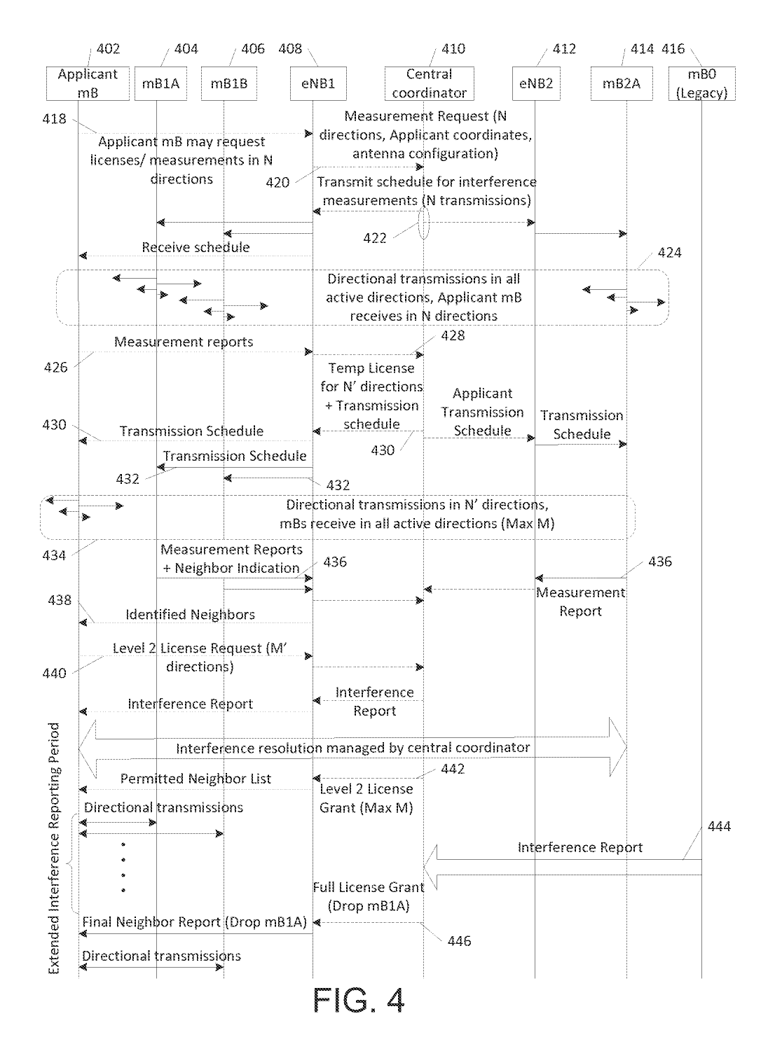

FIG. 4 illustrates an exemplary message sequence chart (MSC) for licensing (e.g., automated licensing). As illustrated in FIG. 4, to register a new link, an applicant mB 402 may send a license request available in a region. The license request may correspond to a beam direction. For example, the applicant mB 402 may request for a set of N beam directions. At 418, the request may be sent to an eNB 408. The eNB 408 may determine if the licensed band link request may be forwarded to the license coordinator (e.g., a central coordinator 410). The eNB 408 may make a decision to forward the request based on factors such as unlicensed spectrum availability in the region, mB bandwidth requirement, etc. The eNB 408 may direct the mB 402 to utilize the unlicensed spectrum for backhaul. At 420, the eNB may forward the link request to the central coordinator 410. The link request may include one or more of position information, antenna specification of the applicant mB, the number of requested directional measurements (N) etc.

At 422, the central coordinator 410 may inform the existing license holders (e.g., mB1A 404, mB1B 406, and/or mB2A) of transmit schedule for the applicant mB 402 to perform interference measurements. This may include the start time and duration of transmission of a pre-defined signal burst (e.g., from applicant mB). The transmit duration may be decided by the number of measurements (N), e.g., as requested by the applicant MB.

The applicant mB 402 may be informed of the transmit schedule for interference measurement (e.g., that is, the transmit schedule may be a measurement schedule for the applicant mB). At 424, the applicant mB 402 may cycle through the desired receive beam directions for each of the transmit slots (e.g., in a frequency band). The applicant mB 402 may send interference measurement for an assigned time period. At 426, the applicant mB 402 may send the interference measurement report comprising interference measurements, e.g., from the desired directions. At 426, the applicant mB 402 may send the interference measurement report to an eNB 408. At 428, the eNB may forward the interference measurement report to the central coordinator 410. The applicant mB 402 may send the interference measurement report to a license coordinator 410. At 430, the central coordinator 410 may grant a temporary license for those directions for which the received signal level may be below a certain threshold. The central coordinator 410 may also send a transmission schedule to the applicant mB. The temporary license may allow the mB to transmit signal bursts at assigned power levels for interference measurements by existing mBs during an assigned interference measurement period. If the reported measurements in certain directions are above the threshold but below another threshold, a conditional temporary license may be granted that may restrict the transmit power to a smaller value. The conditional temporary license may restrict the transmissions to a smaller frequency band. If the applicant accepts the conditional temporary license, it may use the transmit power restriction and/or the smaller frequency band restriction (e.g., at an indicated time) for subsequent interference measurement transmissions and at 434 may transmit data, e.g., upon grant of Level 2 and/or full license.

A measurement may be reported back to a victim license holder. For example, for measurements reported above a threshold, the measurements may be reported back to the victim license holder. Victim license holder may permit temporary license to be granted in those directions because, for example, the victim mB and the applicant mB 402 may belong to the same network and the interference may be internally coordinated. At 432, the central coordinator 410 may inform. the existing license holders about the number of directional transmissions to be performed by the applicant (N′). Similarly, the maximum number of links maintained by an mB in the region (M) may be communicated to the applicant. This may determine the number of transmissions per transmit direction.

If a temporary license is granted, the applicant mB may transmit (M*N′) bursts on the schedule provided to the applicant mB. At 436, the existing mBs may identify potential neighbor mBs, and allow them to evaluate the link quality. Other existing mBs in the region with weak signal reception may report the signal strength as interference. At 438, the central coordinator 410 may send a list of identified neighbors to the applicant mB 402. [Inventors: Please confirm that the preceding highlighted sentences are correct. If not, please explain]

At 440, the applicant mB may apply for a level 2 license in the directions it desires to set up links. Applicants may do so based on neighbor mB measurement results. The coordinator may receive measurement results from the mBs in the region that may have been aggregated by the eNB before transmission to the coordinator. If the reported measurements are below a threshold (e.g., the measurements may be different from the earlier threshold used to grant temporary license) in the license request directions, at 442, the central coordinator 410 may grant the Level 2 license to the applicant mB 402. For example, the grant may be received by the applicant mB via an eNB. The mB may use Level 2 license to transmit millimeter wave data at the granted power level.

Other license holders that did not respond with measurement results for interference assessment may be provided with a time period to request an additional round of interference measurement or to report interference from Level 2 license holders. Possible reasons for the license holders not responding with interference measurement results when requested may include maintenance-related shut-down of mB, operation in hibernate mode to save power, etc. At 444, interference report from the other mBs may be received by the central coordinator 410. At 446, the central coordinator 410 may issue a full license to the applicant mB. The Level 2 license may be converted to full license, and, billing for link use may start. If an existing license holder senses link quality loss, it may request the coordinator to schedule an interference measurement period for the mBs in a region during steady-state operations. The loss may occur due to factors such as change in environmental obstructions, beam orientation, transmit power drift, etc.

A node wishing to surrender some of its active link licenses may send a license surrender message, e.g., to the coordinator, which may include link identifiers for the affected links. The coordinator may send an acknowledgement to the requesting node. The coordinator may check the previously received interference reports to determine if the requesting node during its earlier new node request interference campaign had reported interference, e.g., in the directions for which it is surrendering licenses. If the coordinator determines that a node was denied link license in a direction, e.g., due to interference reported by the node requesting to surrender some link licenses, the coordinator may inform the other nodes about the network topology change. The other node(s) may decide to request a new link license in the previously denied direction. There may a new interference measurement campaign associated with the request.

The automated point-to-point link setup may enable dynamic establishment of directional communication links between individual pairs of nodes in frequency bands that may follow light licensing rules. In automated point-to-point link setup, the license coordinator may not be involved in setting up interference measurement periods and examining measurement reports. An automated interference assessment may ensure that the new point-to-point link does not interfere with pre-existing links, e.g., in the same frequency band.

As illustrated in FIG. 3, it may be assumed that the mBs may have the ability to generate electronically steerable beams to point towards their neighbors. A single and/or multiple simultaneous electronically steerable beams may be assumed to be active at a given time per mB. An eNB may be assumed to be responsible for authenticating the mBs in its network. The eNB may communicate on behalf of the mBs with the coordinator and may hold individual link licenses for its associated mBs. mBs across separate networks may be assumed to be synchronized, e.g., via an accurate common clock source such as Global Positioning System (GPS) reference.

Methods, systems, and instrumentalities are provided to establish directional point-to-point link between the applicant node and its peer. The peer may not interfere with links of existing license holders. Beamforming training may establish directional link with peer node. Interference assessment of the existing directional links may be performed.

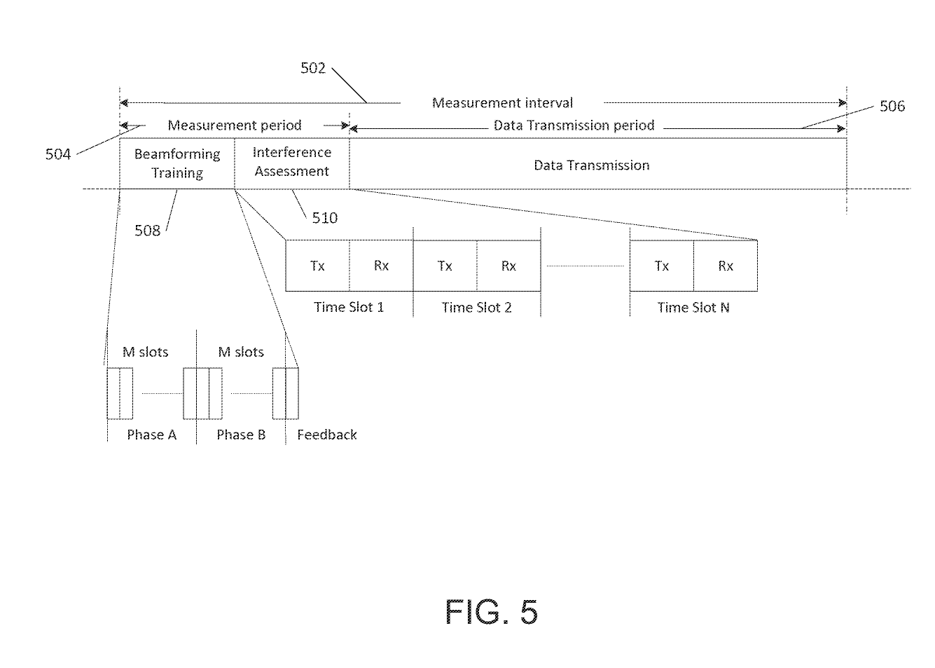

FIG. 5 illustrates an exemplary frame structure of an autonomous link setup. FIG. 5 illustrates the associated timing details. A timing cycle (e.g., measurement interval 502) may comprise of a measurement period 504 and a data transmission period 506. The measurement period 504 and measurement interval 502 may be fixed, system-wide parameters. The measurement period 504 may include beamforming training duration sub period 508 and an interference assessment duration sub period 510. The sub periods may be system-wide parameters. The measurement period 504 may be reserved for measurements associated with link establishment (e.g., a new link establishment).

An mB may request its associated eNB for permission to set up a link. If the MB had previously utilized the requested link, the eNB may allow the requesting mB to proceed to a quick link setup procedure. The applicant mB may request for a new link registration, e.g., after having used and registered the link previously and subsequently relinquishing the registration. The applicant mB may be the current registration holder that may have temporarily suspended transmissions, e.g., due to maintenance, power conservation, and/or other reasons. The mB may have primacy in retaining link registration, e.g., if interference is detected in the quick link setup.

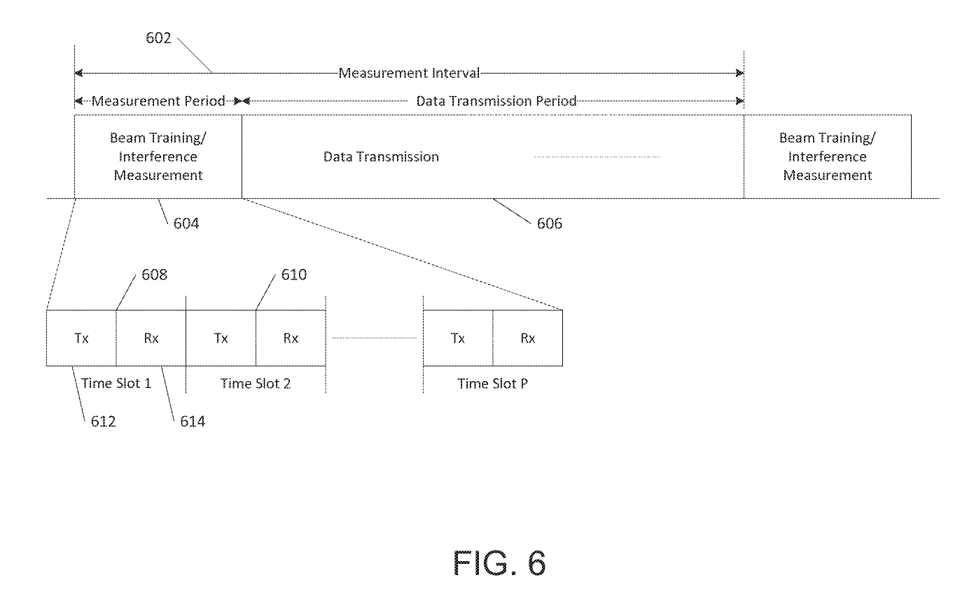

FIG. 6 illustrates an exemplary frame structure in an autonomous link setup (e.g., an optimized autonomous link setup). In an autonomous link setup, a directional point-to-point link may be established between the applicant node and its peer that may not interfere with links of existing license holders. Beamforming training may be used to establish a directional link with a peer node. The interference assessment of the existing directional links may be performed.

As illustrated in FIG. 6, a measurement interval 602 or a cycle may include, e.g., a measurement period 604, a data transmission period 606, etc. The measurement period 604 and measurement interval 602 may be fixed system-wide parameters. The measurement period 604 may be utilized for beamforming training between the peer nodes and for interference assessment, e.g., when a new link is sought to be established. The measurement period 604 may be reserved for measurements associated, e.g., with link establishment (e.g., a new link establishment).

An mB may request its associated eNB for permission to set up a link. If the mB had previously utilized the requested link, the eNB may allow the requesting mB to proceed to quick link setup procedure. The applicant mB may request new link registration, e.g., after having used and registered it previously and subsequently relinquishing registration and/or due to temporary suspension of transmission by the current registration holder because of maintenance, power conservation or other reasons. The mB may have primacy in retaining link registration, e.g., if interference is detected in the quick link setup procedure.

Quick link setup may allow old links to be re-established and used without waiting for a measurement period. The applicant mBs may perform partial interference assessment, e.g., by comparing the observed interference measurements in multiple directions with their stored results from their last use of the link. If measured values match stored results, e.g., within measurement error limits, the mBs may be granted temporary license to begin utilizing the link, e.g., by using the previously configured antenna configuration and transmit power. The mB may perform directional measurements using possible antenna configurations. If directional measurements are substantially similar to previous state (e.g., before link teardown), e.g., within measurement error limits, the applicant mB may request eNB for link re-establishment. If the new link is already registered to an eNB, the eNB may allow the mB to re-start operations, The link re-establishment may occur, e.g., when the mB is taken down for maintenance, or powered down to conserve power without releasing the link registration, etc.

If eNB does not hold the link registration, it may apply for a temporary license to the license coordinator. Upon receipt of the temporary license, the mB may be allowed to begin transmissions. Existing license holders may inform the license coordinator of interference caused due to transmissions on the new link. The coordinator may determine the relative link registration priorities of the two links. It may direct the link with a later registration time or one with temporary license to cease operations. Applicant mB may perform full interference assessment at the next scheduled measurement period. Upon successful completion, a full license may be granted and billing for full license use may commence.

An mB setting up a link for the first time may perform new link setup to gain full license to use the link. An mB trying to re-establish a link may restart operations after quick link setup that may grant the mB a temporary license to use the link or may perform new link setup. At the next scheduled measurement period the mB may perform full interference measurement and acquire a full license. Full license grant may trigger charging by the coordinator.

An applicant mB may request a link license from its associated eNB. The eNB may inform the MB of the duration, periodicity, and/or start time of the measurement periods. The mB may wait till the next measurement period to perform beamforming training with its intended peer, perform full interference measurement, and/or gain full link license. The measurement period may comprise beamforming training duration and/or interference assessment duration. The mB may be informed of some system parameters, e.g., number of allowed antenna configurations for beamforming training (M), the maximum number of simultaneous links allowed per mB (N), etc.

A sub-period may be reserved for beamforming training for new point-to-point link setup between peer nodes. Beamforming training may include, for example, forward beamforming training, reverse beamforming training, and/or feedback. The forward and reverse beamforming training phases may include M slots. Each of the M slots may be fixed, system-wide parameters. During forward beamforming training phase an mB may be involved, e.g., in new link establishment. The mB may transmit up to M consecutive reference packets, with a different antenna configuration, while the other mB may use a fairly wide antenna pattern for reception. In the next phase the roles may be reversed and the mB that was in reception mode earlier may transmit up to M reference packets using different antenna configurations, while its peer uses a fairly wide antenna pattern for reception. The reference packets may be similar, e.g., except for a unique identifier for the receiver to identify the best transmit antenna pattern. For example, in Phase B, the reference packets may include the index number of the packet received with highest quality during Phase A. The originating mB may use that particular antenna pattern for subsequent communications with the peer node. During the feedback phase, the originating mB may inform its peer node the identity of the reference packet received with highest signal quality that may identify the antenna pattern producing the highest quality link. At the end of the beamforming training duration, mBs involved in new link setup may know the antenna configuration to communicate with their peer. If the number of trial antenna patterns at either mB exceeds the number allotted slots for beamforming training (M), beamforming training may continue in the beamforming training duration of the following frame. A stage-wise refinement of beams spanning several measurement periods may be done. Assuming reciprocity of transmit and receive chains at refinement stage, the mBs may use a transmit antenna pattern optimum transmit antenna pattern) discovered in the previous stage for reception. The mBs involved in new link setup may share an independent communication link between them. The nodes may be aware of its geographical location and orientation. The mBs may exchange their positional information over the existing link prior to initiating new link setup to compress the beamforming training duration. The link may be used to determine the mBs to initiate the beamforming training.

Interference assessment duration may be used to determine if the existing point-to-point links are unaffected by the link establishment. An exhaustive measurement procedure may be performed to determine if any of the mBs involved in existing directional point-to-point links experience interference due to the link. The interference assessment duration may be divided into N time-slots, corresponding to the maximum number of individual links permitted per mB in the system. Each of the time-slots may be sub-divided into sub-slots for interference measurement by the nodes that may, e.g., form the link, and for feedback.

As illustrated in FIG, 6, an applicant mB (e.g., in each of its time slots 608, 610, etc.) and its peer mB may transmit signal bursts (in the first sub-slot using antenna patterns discovered, e.g., during beamforming training, while other mBs may receive with their normally used antenna patterns. The existing mBs may cycle through the antenna patterns corresponding to their associated links in successive lime-slots, while the new mBs may transmit, e.g., with their antennas pointing towards each other over each of the time-slots. While a new node may transmit its reference signal in the first sub-slot of each of the time-slots, the existing node may use the second sub-slot to indicate interference to an existing link. To send this feedback, the existing node may send a reference signal during the second sub-slot using, e.g., the antenna pattern used for reception during the first sub-slot. The new node may receive during the second sub-slot with the same antenna pattern used for transmission during the first sub-slot. if the existing and/or new nodes belong to different operators, the presence of a feedback signal during the second sub-slot, e.g., as determined by energy detection or other means, may indicate interference on an existing link. The nodes may suspend new link formation upon receiving a feedback signal in the second sub-slots. If the new and existing nodes belong to the same operator, e.g., due to common signaling procedures, the nodes may exchange information about the interference during the second sub-slot, leading to new link formation with modifications.

The nodes may have full freedom to use the data transmission duration to communicate with their peer nodes while using the appropriate antenna patterns and trans powers used during link establishment. Time split among existing links, choice of modulation on the link, etc. may be determined by the peer nodes or their network operators. Link hoarding may not be allowed by an operator. The maximum number of links per node may be fixed by the system (N). A node using N links may drop a link before it may be allowed to add a new one.

In a full link setup (e.g., an autonomous full link setup), an applicant mB may request a link license from its associated eNB, e.g., via an independent communication link. The eNB may communicate on behalf of the mB with the network controller and/or the central coordinator to manage licenses and schedules. The eNB may convey to the mB the duration, periodicity and/or start time of the measurement periods. The mB may wait till the next measurement period to identify potential neighbors, and/or perform comprehensive interference measurement, and gain full link license. The measurement period may provide identification of potential neighbor, and interference assessment for new links. The mB may be informed of system parameters including, for example, number of allowed antenna configurations for beamforming training (P), the maximum number of simultaneous links allowed per mB (M), etc., e.g., by the serving eNB.

As illustrated in FIG. 6, an exemplary measurement period 604 may be split into P time-slots. Each of the P time slots (e.g., 608, 610, etc.) may be sub-divided into a transmit sub-slot 612 and a receive sub-slots 614. During the transmit sub-slot of each of the time-slots, a new node may transmit a beacon message containing the one or more fields, including, for example, a network identifier, a node identifier, a beam identifier (e.g., identifier of beam used to transmit the beacon message), etc.

The beacon messages may be transmitted, e.g., using a common modulation and coding scheme (MCS), e.g., determined by the central coordinator. The nodes belonging to different networks within communication range may decode these messages. Each of the networks may independently choose an appropriate MCS for beacon transmissions. Decoding of beacons across different networks may not be possible.

The new node may transmit beacons in each of the P time-slots (e.g., the first sub-slot of each of the tine slots) in a measurement period with a common antenna configuration. if the new node supports P different antenna configurations or beams, P measurement periods may transmit beacons using the possible beams.

During the first sub-slot of each of the time-slots, for example, the network nodes may receive with their antennas pointing in one of the possible P directions. The receive direction may be switched at the start of each of the time-slots. In P time-slots, each of the network nodes may sense the P supported directions. A network may support greater number of beam directions (e.g., greater than P) for its nodes. A full scan cycle covering the supported directions may be distributed over multiple measurement periods. A new node at start up may be informed of the full scan cycle duration. If a node belonging to the same network as the new node successfully decodes the beacon message transmitted by the new node using one of P beams in the first sub-slot of one of the P time-slots in a measurement period, the node may respond with a beacon response message containing one or more fields including, for example, a network identifier, a node identifier, a beam identifier (e.g., identifier of beam resulting in successful beacon reception), etc. The responding node may be identified as a potential neighbor by the new node. The new node may request directional link license in the direction of the newly discovered neighbor.

If an existing node belonging to a different network than the new node has its beam pointed in the direction of the new node's transmit beam, the existing node may be able to decode the transmitted beacon, e.g., if it is within communication range of the new node, and may use the same MCS class. If the receive direction is a part of one of its active links, the network node may respond with a beacon response message including its network, node and beam identifiers. Upon receiving the beacon response, the new node may know that transmission on a beam would cause interference to an existing link and may not apply for a license in that direction in the subsequent step. If the node belonging to a different network uses a different MCS, it may sense signal energy due to the beacon transmission by the new node, e.g., using energy detection principles. If the receive direction is part of one of its active links, the network node may respond during the second sub-slot of the same time-slot by transmitting the beacon response message, e.g., using the same beam and MCS adopted by its network. The new node may sense increased signal energy during the second tub-slot and may stop using that beam for further communications.

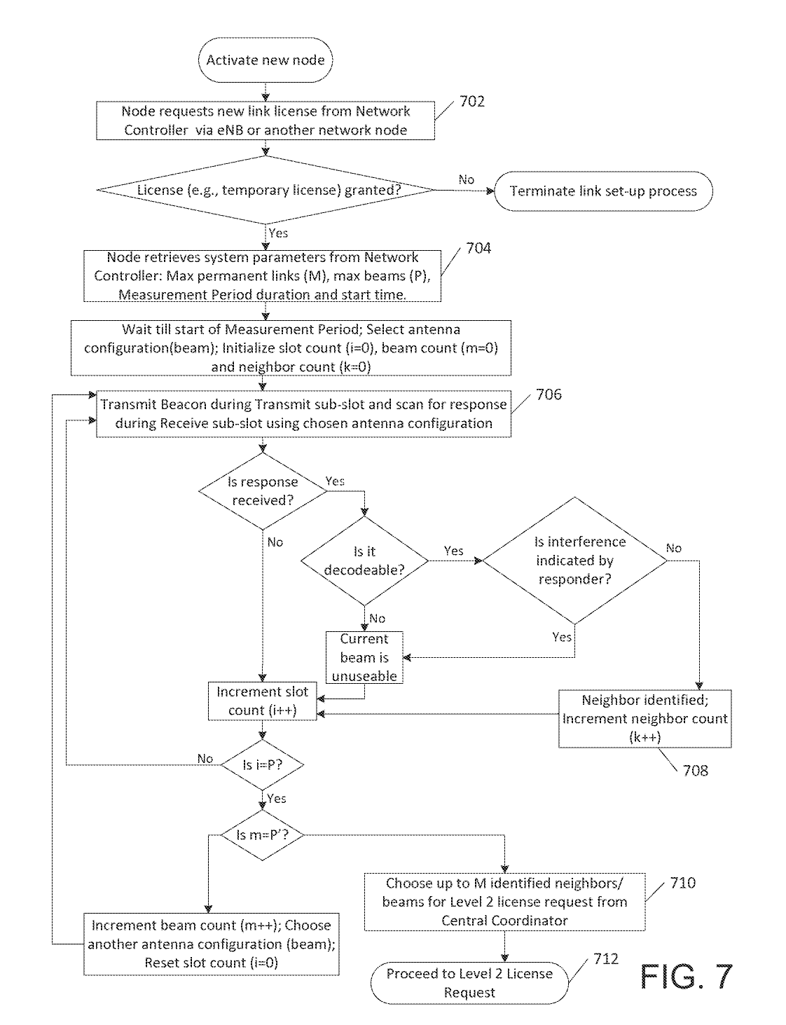

FIG. 7 illustrates an example of setting up an autonomous full link setup (e.g., optimized autonomous full link setup). As illustrated in FIG. 7, at 702, a node (e.g., a new node) may request a link license from a network controller via an eNB or an independent link through a neighboring node. The communications to the network controller may be sent via the eNB or a network node during the Measurement Period messaging. At 704, the node may receive the frame schedule of a point-to-point network (e.g., an existing point-to-point (network) from the eNB or a neighboring node. The node may receive the frame schedule, e.g., via a link (e.g., an independent and/or temporary link) to enable an initial start-up. At 706, the node or mB may begin beacon transmissions (e.g., directional beacon transmissions) at the assigned time. The beacon transmissions may use the antenna beam-width for data transmission. The mode of mB may have P′ antenna configurations (e.g., beams) to try out. The mB may spread transmissions for each of the P′ directions (e.g., over P′ consecutive Measurement Periods).

At 708, the mB may identify each of the potential neighbors from the received responses of the P′ configurations. At 710 the mB may choose some or all of the neighbors for Level 2 license. At 712, the mB may apply for Level 2 licenses for some or all of the directions in which the mB may have identified potential neighbors. The license requests may be sent to the Central Coordinator, e.g., via the serving eNB or neighboring node. The mB may start data transmissions in the permitted directions. The mB may exchange one or more coordination messages with the neighbors for which Level 2 license may be granted during the Measurement Period before starting transmissions during the Data Transmission Period (e.g., as illustrated in FIG. 6).

Other license holders that did not respond during the Measurement Period may be allowed a period of time to report interference from Level 2 license holders. Possible reasons for the license holders not to respond during Measurement Period may include one or more of maintenance-related shutdown of mB, operation in hibernate mode to save power, or legacy mode of operation. At the end of the extended interference measurement reporting period, the Level 2 license may be converted to a full license, and billing for link use may start.

One or more nodes may have full freedom to use the data transmission duration to communicate with their peer nodes while using the appropriate antenna patterns and transmit powers used during link establishment. Time split among existing links, choice of modulation on each link, etc, may be determined by the peer nodes or their network operator. Link hoarding by an operator may not be allowed, since the maximum number of links per node is fixed by the system (M). A node using M links may drop a link before it may be allowed to add a new one.

A node that may wish to surrender some of its active link licenses may send a license surrender message to the coordinator including link identifiers for the affected links. The coordinator may send an acknowledgement to the requesting node. The coordinator may inform the network controllers about the network topology change. The network controllers may establish a schedule for their established nodes in the area to perform interference measurement campaign to identify possibilities for additional link setup.

A license holder for a link may lease out some portion of the link resources to a different network operator, e.g., based on one or more requirements. The original license holder may still be responsible for fulfilling licensing requirements such as proving measurement reports to the license coordinator. Link sharing may be transparent to the license coordinator, or the secondary user may register with the coordinator. The primary license holder may be responsible for the link charges to the coordinator and charges the secondary license holder independently. The primary and/or secondary license holders may be responsible (e.g., directly responsible) for their portions of link charges to the link coordinator.

The charging rate for each of the links may depend on one or more factors including, for example, location of an mB, time of day, etc. A license coordinator may specify one or more different peak and/or non-peak time rates that may have different tiers. Link charges may depend on location, for example, a point-to-point link in a downtown location between two street corners, surrounded by tall buildings on both sides (e.g., urban canyon) may be charged at a higher rate, due to possibility of fewer links in the region due to restricted field-of-view. The link rates may be communicated to the license holding eNB, e.g., during initial link registration request based on mB position and transmitter specifications.

Regulatory specifications for lightly licensed bands may specify stringent antenna requirements, corresponding to highly directional beams (e.g., directional pencil beams). Such bands may be used for long-range point-to-point links. The narrow beams may require expensive antennas and may be used for long-range communications. Antennas with wider beams may potentially interfere with more users, thereby impacting system-wide capacity. A flexible antenna configuration system that may specify antenna capability linked power transmission limits may be used.

Regulations for lightly licensed frequency spectrum may require a maximum equivalent isotropically radiated power (EIRP) limit. Minimum antenna gains may be specified for these frequencies. Antennas with smaller gains may be allowed with certain restrictions. The restrictions may limit the maximum transmit power and/or the EIRP, For example, the regulations may state that for X dBi drop in antenna gain, the transmit power may reduce by Y dBm, resulting in (X+Y) dB drop in EIRP. The transmit power drop requirement may be specified so that the area, e.g., over which the wide-beam signal may be received above a particular power threshold may be the same as the area over which the narrow-beam signal may be received with the same threshold.

The antenna capabilities (e.g., minimum beamwidth, maximum gain, etc.) may be communicated by a new node to the regulator's server, e.g., at the time of link registration. If a per-link cost model is used, differential costs may be unposed by the regulator for different antenna beamwidth and/or transmit power combinations.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, optical media such as CD-ROM disks, and digital versatile disks (DVDs). A processor in association with software may be used to implement a radio frequency transceiver for use in a WTRU, WTRU, terminal, base station, RNC, or any host computer.

What is claimed:

1. A method for point-to-point communication setup, the method comprising:
sending a license request associated with a beam direction in a frequency band;
receiving a measurement schedule;
taking an interference measurement in accordance with the measurement schedule, wherein the interference measurement is associated with one or more of the beam directions, the frequency band, or an assigned time period;
sending the interference measurement report; and
receiving a temporary license for the beam direction in the frequency band.

2. The method of claim 1, wherein the license request comprises one or more of position information, an antenna specification associated with a millimeter wave base station (mBs), or a number of requested directional measurements.

3. The method of claim 1, wherein the measurement schedule comprises one or more of a start lime, or a transmission a signal burst duration.

4. The method of claim 1, wherein the interference measurement is associated with an existing licensed node.

5. The method of claim 1, wherein the temporary license includes a first transmit power restriction.

6. The method of claim 1, wherein the temporary license is received when the interference measurement is below a first threshold value.

7. The method of claim 5, further comprising:
receiving an instruction to send a signal burst;
sending the signal burst using the first transmit power restriction; and
receiving a non-temporary license, wherein the non-temporary license includes a second transmit power restriction.

8. The method of claim 7, further comprising accepting the non-temporary license.

9. The method of claim 8, further comprising sending a transmission using the non-temporary license and the second transmit power restriction.

10. The method of claim 7, wherein the non-temporary license is a level 2 or a full license.

11. The method of claim 1, further comprising:
sending a link surrender message, wherein the link surrender message comprises a link identifier; and
receiving an acknowledgement for the link surrender message.

12. The method of claim 1, wherein the interference measurement is sent to a license coordinator.

13. The method of claim 12, wherein the interference measurement is sent to a license coordinator via an evolved NodeB.

14. A millimeter base station (mB) configured for point-to-point communication comprising:
a processor configured to:
send a license request associated with a beam direction in a frequency band;
receive a measurement schedule;
take an interference measurement in accordance with the measurement schedule, wherein the interference measurement is associated with one or more of the beam direction, the frequency band, or an assigned time period;
send the interference measurement to a license coordinator; and
receive a temporary license for the beam direction in the frequency band.

15. The mB of claim 14, wherein the license request comprises one or more of position information, an antenna specification associated with a millimeter wave base station (mBs), or a number of requested directional measurements.

16. The mB of claim 14, wherein the measurement schedule comprises one or more of a start time, or a transmission a signal burst duration.

17. The mB of claim 14, wherein the interference measurement is associated with an existing licensed node.

18. The mB of claim 14, wherein the temporary license includes a first transmit power restriction.

19. The mB of claim 14, wherein the temporary license is received when the interference measurement is below a threshold value.

20. The mB of claim 18, wherein the processor is further configured to:
receive an instruction to send a signal burst;
send the signal burst using the first transmit power restriction; and
receive a non-temporary license, wherein the non-temporary license includes a second transmit power restriction.

21. The mB of claim 20, wherein the processor is further configured to accept the non-temporary license.

22. The mB of claim 21, wherein the processor is further configured to send a transmission using the non-temporary license and the second transmit power restriction.

23. The mB of claim 20, wherein the non-temporary license is a level 2 or a full license.

24. The mB of claim 14, wherein the processor is further configured to:
send a link surrender message, wherein the link surrender message comprises a link identifier; and
receive an acknowledgement for the link surrender message.

25. The mB of claim 14, wherein be interference measurement is sent to a license coordinator.

26. The mB of claim 25, wherein the interference measurement is sent to a license coordinator via an evolved NodeB.
